(19) United States
(12) Patent Application Publication
(10) Pub. No.: US 2004/0023690 A1
(43) Pub. Date: Feb. 5, 2004

(54) Remote counting system, remote counting method, and computer-readable medium

(76) Inventors: Hiroyuki Kamiya, Fukui-shi (JP); Yoshimi Washida, Fukui-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/211,250

(22) Filed: Aug. 5, 2002

(51) Int. Cl. H04M 11/00; H04M 1/00; H04B 1/38

(52) U.S. Cl. 455/560; 455/405

(57) ABSTRACT

Provided are a remote counting system, a remote counting method, and a computer-readable medium, with which it becomes possible to achieve labor saving in tabulating work and to expedite the tabulating work. A remote counting system includes a portable terminal (2) that is capable of being carried to a counting place and a remote counting server (3) that is connected to the portable terminal (2) through a communication line. In this system, the portable terminal (2) sends a button pushing operation signal inputted by the pushing of an input button to the remote counting server (3) through the communication line. The remote counting server (3) identifies communication from the portable terminal (2), detects the button pushing operation signal from each portable terminal, records the number of operations for pushing the buttons of the portable terminal (2) on the basis of the detected button pushing operation signal, and performs tabulation.

### BACKGROUND OF THE INVENTION

1. Field of the Invention

The present invention relates to a remote counting system, a remote counting method, and a computer-readable medium that are suited for a traffic survey that performs counting of subjects on a street, an exit poll conducted during voting, or a questionnaire survey conducted at an event or the like. In particular, the present invention relates to a “ONE CLICK COUNTER” that performs a count-up operation at a remote counting server in accordance with the clicking on a button of a terminal once.

2. Description of the Related Art

Until now, during an exist poll for election, an investigator hands a questionnaire to each voter, who is an target person for survey, at a polling place and requests the voter to fill in the questionnaire. The filled-in information is transmitted to a counting place by a fax or a telephone and the transmitted information is counted at the counting place.

However, this method is beset by two major problems that should be solved. The first problem is how to achieve labor saving in tabulating work and to expedite the tabulating work. During voting, great many persons visit polling places in respective districts within a predetermined time period. That purpose persons conducting an exist poll must be tabulating work in large quantity within this limited time period. In this way the survey work is heavy load.

Accordingly, in order to conduct this survey work smoothly and with precision, a great many investigators and persons in charge of tabulation are deployed, which incurs a situation where there is spent a huge cost (labor cost). Note that it is conceivable that the labor cost is reduced by having one investigator concurrently hold a plurality of polling places. In this case, however, there is a probability that the survey accuracy is lowered because the survey is conducted during different time periods at respective polling places.

The second problem is Security of anonymity. It is possible for an investigator to peep information written on a form in the case of a conventional exit poll, so that there is a probability that a target person for survey writes fictitious information due to a psychological reason.

The present invention has been made to solve the problems described above, and an object of the present invention is to provide a remote counting system, a remote counting method, and a computer-readable medium, with which it becomes possible to achieve labor saving in tabulating work and to expedite the tabulating work.

Another object of the present invention is to provide a remote counting system, a remote counting method, and a computer-readable medium, with which it is possible to ensure anonymity during an input operation and to improve the accuracy of inputted information.

### SUMMARY OF THE INVENTION

With the remote counting system, remote counting method, remote, and computer-readable medium for the same of the present invention, counting is performed by pushing input buttons of a portable terminal, a signal representing this button pushing operation is sent to a remote counting server, button pushing operation signals from a plurality of portable terminals are collectively provided at this remote counting server, and processing is performed.

That is, information for counting is directly inputted as an electric signal by a button pushing operation and this information is counted and tabulated, thereby achieving labor saving in tabulating work and expediting the tabulating work.

Also, the inputting is performed by a simple operation that is a button pushing operation, so that it becomes possible to allow an target person for survey to directly input his/her answers by handing the portable terminal to him/her. As a result, there is maintained anonymity during the inputting and there is improved the accuracy of inputted information.

According to the present invention, there is provided a remote counting server that is connected to a portable terminal, including: an identifying unit that identifies communication with each of a plurality of portable terminals; a detecting unit that detects a button pushing operation signal generated by each identified portable terminal when an input button is pushed; a counting unit that records the number of button pushing operations for each portable terminal based on the button pushing operation signal; a tabulating unit that tabulates the counting results for all the portable terminals and/or each portable terminal; and an outputting unit that visually outputs a result of the tabulation.

With this construction, there is realized a remote counting server that makes it possible to achieve labor saving in tabulating work, to expedite the tabulating work, and to improve the accuracy of inputted information.

Also, there may be obtained a construction where the remote counting server is connectable from a portable terminal having a display apparatus and identifies a portable terminal of the communication opposite party under a connection state using the display apparatus.

With this construction, it becomes possible to adopt a mobile telephone or the like equipped with a display apparatus that is capable of browsing a Web page on the Internet as the portable terminal, which enables the counting through the Internet.

Also, it becomes possible to perform an input operation while having the display apparatus display information necessary for the input operation, such as the correspondences between input items and input buttons. As a result, operability improves during the input operation.

Further, there may be obtained a construction where the remote counting server is connectable from a voice communication terminal and detects the button pushing operation signal as a voice signal.

With this construction, a mobile telephone or the like only with a conversation function may be adopted as the portable terminal, which enhances versatility.

Also, there may be obtained a construction where the remote counting server includes a counting information sending unit that sends information concerning counting to the portable terminal.

With this construction, it becomes possible to confirm information concerning counting, such as counting results, a counting state (total at the current point in time and the like), and an item that should be inputted next, on the portable terminal side.

According to the present invention, there is provided a remote counting method that is applied to a remote counting server connected to a portable terminal, includes: identifying communication with each of a plurality of portable terminals; detecting a button pushing operation signal generated by each identified portable terminal when an input button is pushed; recording the number of button pushing operations for each portable terminal based on the button pushing operation signal; tabulating the recorded number of button pushing operations for all the portable terminals and/or each portable terminal; and outputting a result of the tabulation.

According to the present invention, there is provided a computer-readable medium that stores a remote counting program, wherein a remote counting server connected to a portable terminal is allowed to execute: identifying communication with each of a plurality of portable terminals; detecting a button pushing operation signal generated by each identified portable terminal when an input button is pushed; recording the number of button pushing operations for each portable terminal based on the button pushing operation signal; tabulating the recorded number of button pushing operations for all the portable terminals and/or each portable terminal; and outputting a result of the tabulation.

In the present invention, aside form a CD-ROM or DVD that is a storage medium mountable to a computer system constituting a server, the computer-readable medium may be a magnetic recording medium (such as a FD, magnetic tape, or DAT), a magneto-optical recording medium (such as an MO or MD) a semiconductor memory (such as a CF or MMC), or the like. That is, there occurs no problem so long as the computer-readable medium is capable of storing a program in a predetermined format. Also, the computer-readable medium includes a hard disc or a semiconductor memory on which various kinds of application software has been preinstalled and which has been mounted to a computer.

According to the present invention, there is provided a remote counting system, comprising a portable terminal that is capable of being carried to a counting place and a remote counting server that is connected to the portable terminal through a communication line. The portable terminal includes: an input button that inputs a button pushing operation signal through the pushing thereof; and a sending unit that sends the button pushing operation signal inputted using the input button to the remote counting server through the communication line. The remote counting server includes: an identifying unit that identifies communication with the portable terminal; a detecting unit that detects the button pushing operation signal from the identified portable terminal; and a counting unit that records the number of button pushing operations of the portable terminal based on the detected button pushing operation signal.

With this construction, there is realized a remote counting system that makes it possible to achieve labor saving in tabulating work, to expedite the tabulating work, and to improve the accuracy of inputted information.

Also, in the remote counting system, the portable terminal may be a mobile telephone having, as the input button, at least one of keys for dialing and a pointing device.

It should be noted here that the input button includes numerical buttons from “0” to “9”, mark buttons such as “*” and “#” buttons, an operation lever, and a dial. Additionally, the input button is a pointing device, such as an operation lever or a dial, which is operated to select an arbitrary position (alternative) and to click the position for determination, or the like.

Also, in the remote counting system, a predetermined button pushing operation signal may be inputted by pushing the input button once and the counting unit may perform the counting once in accordance with the predetermined button pushing operation signal; the server may include a tabulating unit that tabulates button pushing operation signals from a plurality of portable terminals; and a voting result obtained as a result of an exit poll at a polling place may be inputted as a button pushing operation signal by the input button of each portable terminal and the tabulating unit of the server may judge who is sure to be elected by tabulating the button pushing operation signals from the respective portable terminals.

In the present invention, there occurs no problem so long as the portable terminal has a construction where the portable terminal is capable of being carried to a counting place and sending a button pushing signal to the server through a communication line. For instance, the portable terminal is a mobile telephone, a PHS(personal handy phone system), a PDA(personal digital assistant) with a modem, or the like.

In the present invention, it is possible to combine the respective constructions described above in a possible range.

### BRIEF DESCRIPTION OF THE DRAWINGS

In the accompanying drawings:

FIG. 1 is a drawing showing a schematic construction in accordance with a first embodiment of the present invention;

FIG. 2 is a drawing showing the schematic construction of a remote counting server of the first embodiment of the present invention;

FIG. 3 is a drawing showing the schematic construction of a mobile telephone of the first embodiment of the present invention;

FIG. 4 is an explanatory drawing concerning a procedure (remote counting method) for performing an exit poll;

FIGS. 5A to 5D are each a drawing showing an example screen displayed by a portable terminal in the first embodiment of the present invention;

FIG. 6 is an explanatory drawing concerning survey results stored in a database;

FIG. 7 is a drawing showing a schematic construction of a remote counting server 3 in a second embodiment of the present invention;

FIG. 8 is a drawing showing correspondences between survey items and input buttons; and

FIG. 9 is a drawing showing a modification of a third embodiment of the present invention.

### DETAILED DESCRIPTION OF THE PREFERRED EMBODIMENTS

### First Embodiment

Embodiments of the present invention will be described below in conjunction with illustrated examples.

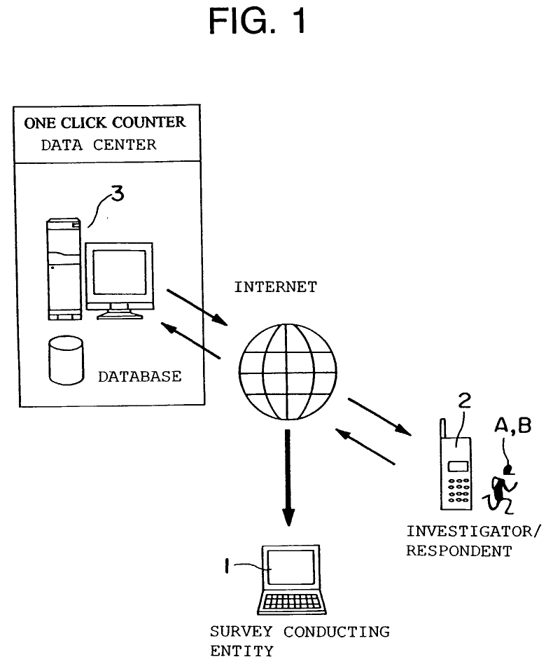

FIG. 1 is a drawing showing the schematic construction of a first embodiment according to the present invention.

A remote counting system (one click counter) of this embodiment includes a user terminal 1 that is used by a user of data, who is the entity conducting an survey, to request the survey or the like, a portable terminal 2 that is carried by an investigator and performs counting at a survey place (counting place), and a remote counting server 3 that is provided in a data center and performs counting and tabulating of information from a plurality of portable terminals 2 connected through transmission paths (communication lines). With this system, the survey conducting entity requests an exit poll during election, each investigator carrying the portable terminal 2 is deployed at a polling place on the basis on the request, the investigator conducts the exit poll, each survey result from the portable terminal 2 is counted and tabulated in real time at the server 3, and a result of the tabulating is provided for hour-by-hour reports of the election returns or the like.

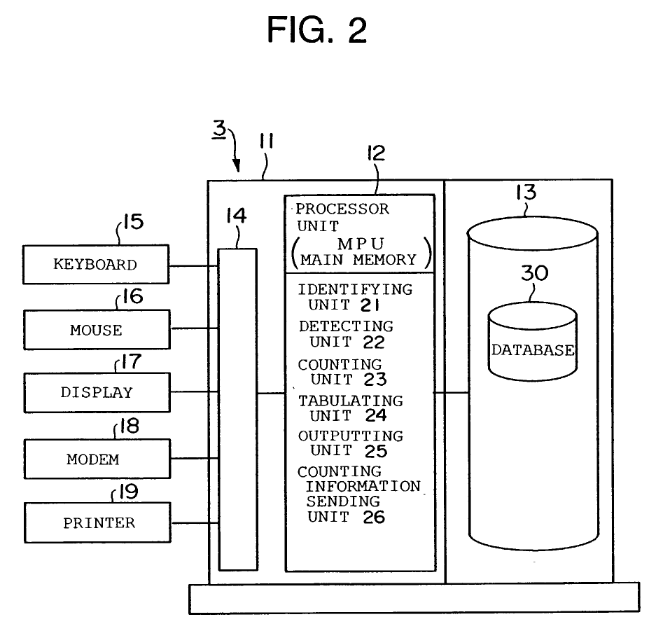

As to the remote counting server 3, as shown in FIG. 2, a processor unit 12 including an MPU (micro processor unit), a main memory, and the like, a hard disc (solid-state magnetic storage apparatus) 13 in which there is stored software for performing arithmetic processing, an input/output port 14 that is an input/output portion for these data, and the like are provided within a main body 11.

Also, peripheral equipment, such as a keyboard 15, a mouse 16, a display 17, a modem 18, and a printer 19, is connected to the main body 11 through the input/output port 14.

An operating system (OS) and application software are installed on the hard disc 13 in the main body 11.

The processor unit 12 realizes an identifying unit 21, a detecting unit 22, a counting unit 23, a tabulating unit 24, an outputting unit 25, and a counting information sending unit 26 through processing based on information from the peripheral equipment and the application software.

The identifying unit 21 has a function of identifying communication from each of a plurality of portable terminals.

The detecting unit 22 has a function of detecting a button pushing operation signal that is generated by each identified portable terminal when an input button is pushed.

The counting unit 23 has a function of recording the number of button pushing operations for each portable terminal on the basis on the button pushing operation signal.

The tabulating unit 24 has a function of tabulating counting results for all the portable terminals and/or each portable terminal.

The output unit 25 has a function of visually outputting a result of the tabulating by the tabulating unit 24. That is, the output unit 25 performs displaying of the result on the display 17 or printing thereof using the printer 19. Note that the present invention is not limited to the form where the result is directly displayed or printed. That is, the present invention may be applied to a form where the result is recorded on a medium using a printing code or a predetermined file format and another device displays or prints the result.

Also, the counting information sending unit 26 sends, to the portable terminals, information concerning the counting, such as information giving the current state of the counting, the next alternatives, and the like.

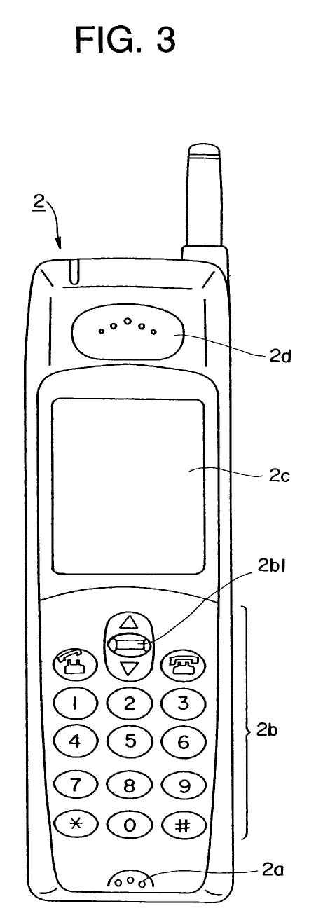

On the other hand, each portable terminal 2 is a general mobile telephone. As shown in FIG. 3, a microphone 2a for conversation and input buttons 2b for inputting a telephone number or the like are arranged in the lower portion on the front side of the entity 20, while a display portion 2c and a speaker 2d are arranged in the upper portion on the front side.

It should be noted here that as the input buttons 2b, there are arranged numerical buttons from “0” to “9”, mark buttons such as “*” and “#” buttons, an operation lever (pointing device) 2b1, and the like.

In addition to a conversation function, the mobile telephone 2 in this example has a function of performing the sending and reception of a mail through connection to the Internet and a function of browsing a Web page by having the display portion 2c display the Web page.

The user terminal 1 is a so-called personal computer, is connected to the remote counting server 3 through the Internet, and issues a request to conduct a survey.

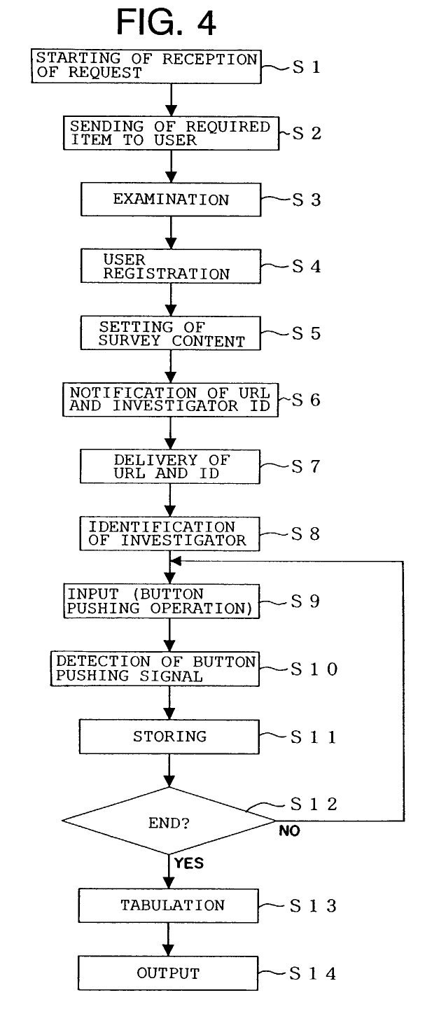

Next, a procedure for conducting an exit poll (remote counting method) using these constructions will be described with reference to FIG. 4.

First, the data center that counts and tabulates data and provides a tabulating result as an ASP (Application Service Provider) receives a request to conduct a survey through a Web site provided by the server 3 (step 1, each step will be hereinafter abbreviated like “S1”).

In contrast to this, a survey conducting entity, such as a television station or a newspaper publishing company, that is trying to conduct an exit poll performs user registration by accessing the Web site.

First, the survey conducting entity selects a page for the user registration from a home page, inputs required items in accordance with a form determined by an operator of the site, and then pushes a send button, thereby filing an application (S2). As the input items, there are included a company name, a representative's name, contact information, a payment method, and the like.

The operator (data center) of the server 3 that has received this application examines the application in the light of predetermined standards (S3). In the case where the application is approved, the server 3 issues a user ID and a password and informs the survey conducting entity of the ID and password. The server 3 also registers the aforementioned inputted items, user ID, and password in a database 30 on the hard disc 13 for each user (S4).

Then, the registered survey conducting entity requests a survey.

The survey conducting entity access the site using the user terminal 1, receives approval by inputting the user ID and password described above, proceeds to a page through which it requests the survey, and sets the contents of the survey by answering to questions specified by the operator of the site in an interactive manner (S5).

The survey items in this example are the gender of a voter, the political party he/she supports, and the candidate for whom he/she voted. In addition to these items, there are also set a survey place (polling place), the number of investigators deployed at each survey place, the mail address of the portable terminal 2 of each investigator, and the like.

In this example, three persons “J, K, and L” stand as candidates, two places “1 and 2” are selected as polling places, and two persons “A and B” work as investigators.

The server 3 generates a home page for the survey that displays selection items and receives selection results during the survey on the basis of the survey items and setting items described above. The server 3 then informs the survey conducting entity of the URL (Uniform Resource Locator) of this home page. The server 3 also automatically assigns an ID for each investigator in addition to the above operations, and informs the survey conducting entity of this ID (S6).

The survey conducting entity delivers the URL of the survey page and the ID to each of the investigators A and B by e-mail, with the URL and ID being delivered at the same time or separately (S7). The URL for the survey page and the ID may be directly delivered by the server 3 to each investigator A or B by e-mail.

Each investigator A or B receives the e-mail sent by the survey conducting entity through a transmission path, opens the received e-mail when he/she starts the survey, clicks the URL of the page for the survey described in the e-mail, and accesses the survey page using a link function. In contrast to this, the server 3 requests the input of the ID and identifies the investigator using this ID (S8).

Then, each investigator A or B asks a voter (target person for survey), who has voted, about his/her gender, the political party he/she supports, and the candidate for whom he/she voted. And, the investigator inputs the voter's answers from the portable terminal 2. Alternatively, the investigator hands the portable terminal 2 to the voter to allow him/her to input the answers by himself/herself.

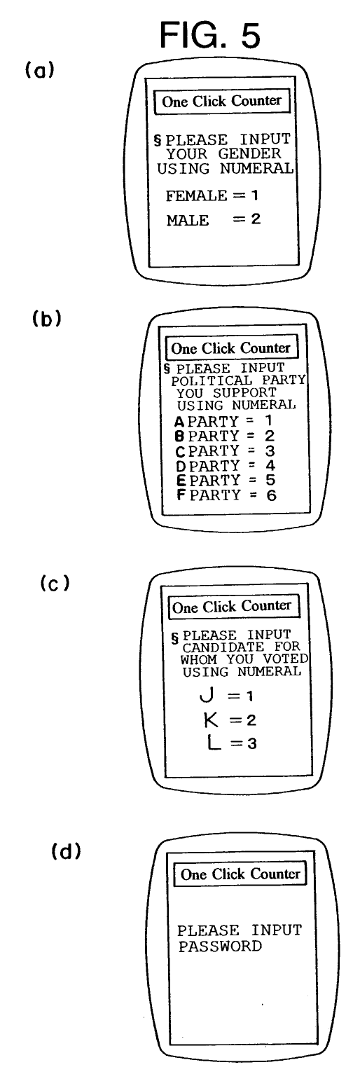

When doing so, selection items are displayed on the display portion 2c of the portable terminal 2 as shown in FIGS. 5A to 5D, thereby requesting the inputting of corresponding numerical buttons.

First, as shown in FIG. 5A, the gender is inputted using a numerical button 1 or 2 (S9).

That is, if the voter is female, the numerical button 1 is pushed and a signal showing that this button has been pushed is sent to the server 3. The server 3 that has detected this button pushing signal (S10) stores this signal as gender information (S11), and displays a page giving the next question using the function of the counting information sending unit 26 as shown in FIG. 5B. In the case where a signal other than a predetermined signal (1 or 2) is inputted, an error message is returned in order to request re-inputting.

In a like manner, the voter inputs the political party he/she supports using a corresponding numerical button. When a button pushing signal is detected by the server 3, there is displayed the next question as shown in FIG. 5C.

Then, the voter inputs the candidate for whom he/she voted using a corresponding numerical button. When the server 3 detects a button pushing signal, all questions that should be answered by one voter have been answered and the display portion returns to the screen shown in FIG. 5A. Consequently, the investigator receives the portable terminal 2 from the voter to whom the investigator handed the terminal 2. Then, the investigator proceeds to the inputting by the next target person for survey.

Note that the following construction may be adapted in order to prevent a situation where the same voter continuously performs the input operation. When all of the questions have been answered, a password input screen is temporarily displayed as shown in FIG. 5D, a signal is inputted through the pushing of predetermined buttons (for instance, a password or investigator ID with several digits), and the display portion returns to the screen shown in FIG. 5A.

The inputting for these survey items is repeated until a predetermined time has elapsed or the number of subjects investigated reaches a predetermined number of samples (S12).

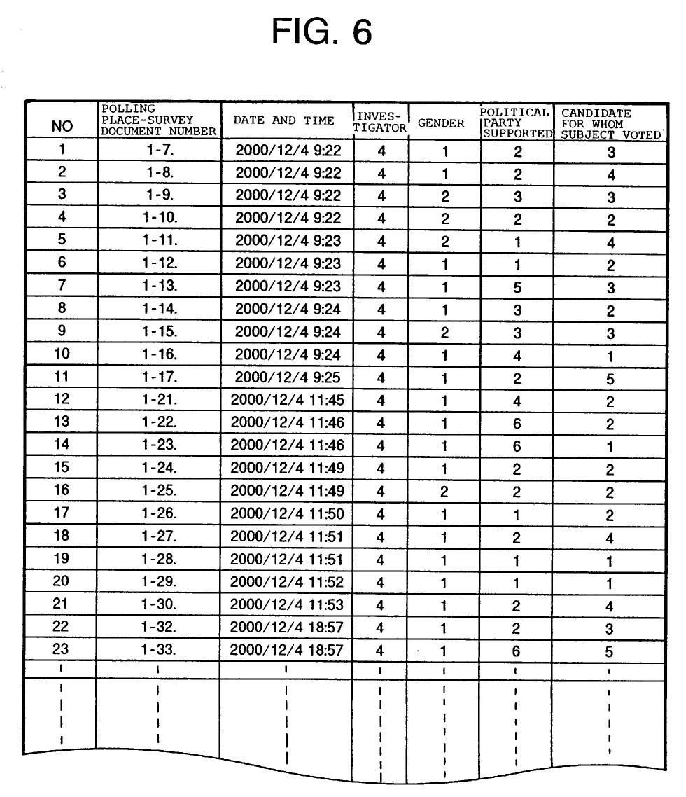

FIG. 6 is an explanatory drawing of information (survey result) sent from the portable terminal 2 of the investigator A and stored in the database of the server 3.

As shown in this drawing, information concerning each survey item that the server 3 received specifies the investigator's terminal 2, from which the information has been sent, on the basis of the investigator ID. Then, the information is given data concerning the polling place at which this investigator was deployed (polling place-survey document number), a serial No., the date and time the survey was conducted, and the investigator ID, and is stored as one record for each target person for survey.

The data concerning the polling place is composed of a number showing the polling place, at which the investigator was deployed, and a number assigned to an survey document (survey document number). This survey document number is a serial number assigned to each survey document in the case where the survey is concurrently conducted using paper survey forms (survey documents). With this construction, it becomes possible to check tabulating results obtained with the present system against survey results obtained using the paper survey forms.

Also, the survey results sent from the portable terminal 2 of the investigator B are stored in the database 30 in a like manner, the ratio of votes of each candidate, the approval rate of each political party, the ratio of males to females of these, and the like are calculated by tabulating the survey results (S13), and the tabulating results are provided for the survey conducting entity (S14).

During vote counting, the survey conducting entity makes the judgment concerning who is sure to be elected by utilizing information concerning this ratio of votes obtained and the like.

As described above, with the technique of this embodiment, counting is performed (one set of data is additionally stored in the database) merely by pushing a numerical button once for each question (by performing “One Click” operation), so that there is realized a one click counter that performs counting through simple work.

Also, at a point in time when the counting is performed, a counting result is sent to the server 3 as information, so that it becomes possible to eliminate the work for tabulating that has conventionally been performed to tabulate paper survey forms using human power.

It is also possible to perform this tabulating in real time. Further, there is improved the flexibility concerning the use of data through cross tabulation, the downloading at CSVs, and the like. A unique ID is given to each investigator, so that it becomes possible to manage the state of the survey for each survey terminal. In the case where survey based on paper is concurrently conducted, it is possible to check paper survey forms against digital information.

Further, the portable terminal 2 is handed to a target person for survey to allow him/her to directly input his/her answers, so that there is maintained anonymity.

In particular, the widespread use of mobile telephones allows ordinary people to sufficiently understand the high degree of concealment of the contents sent, so that there is prevented, with a high degree of effectiveness, a situation where each target person for survey inputs fictitious information because he/she fears that the information may be revealed.

### Second Embodiment

In the first embodiment described above, the survey conducting entity employs investigators in advance. In this embodiment, however, the data center recruits investigators, registers them, and distributes a survey request to the registered investigators.

It noted here that other constructions of this embodiment are the same as those in the first embodiment described above, so that the same construction elements are given the same reference numerals and the description thereof is omitted.

First, the data center recruits investigators on the Web, using a part-time job information magazine, or the like.

Each person applying for the recruitment of investigators accesses a home page specified by the data center, inputs answers to predetermined items, and pushes a send button. In this manner, he/she sends an application. The input items are his/her name, address, age, contact information, telephone number of a mobile telephone to be used for the survey, model of the mobile telephone, mail address, FAX number, nearest station, and the like.

The data center that has received the application examines the applicant in the light of predetermined standards. For instance, it is examined whether the applicant is at least equal to a predetermined age and whether the mobile telephone to be used is a model that is connectable to the Internet.

Each person approved as a result of this examination is employed as an investigator. The server 3 issues an investigator ID and a password and informs the investigator of the ID and password and that he/she has been approved. The server 3 also registers the inputted items described above, the investigator ID, and the password for each investigator in the database 30 on the hard disc 13.

Following this, in the case where receiving a request to conduct an survey from the survey conducting entity, the server 3 extracts investigators from the database on the basis of the input items and the like. For instance, there is extracted each investigator who lives near a survey place.

The server 3 delivers the contents of the survey and an URL of a page for the survey to each extracted investigator. Note that by delivering different URLs to respective investigators, there may be specified each investigator who accesses this URL and sends survey information.

As described above, in this embodiment, investigators are registered on the data center side, so that there is reduced the load placed on the survey conducting entity side.

Also, it becomes possible to stationary get hold of investigators who are used to a survey where the present system is used.

### Third Embodiment

In the first embodiment described above, there has been described an example where the portable terminal 2 is connected to the server 3 through the Internet. In this embodiment, however, there will be described a construction where the portable terminal 2 is connected to the server 3 through a telephone line and each tone signal from the portable terminal 2 is counted by the server 3. Note that other constructions are approximately the same as those in the first embodiment, so that the same construction elements are given the same reference numerals and the description thereof is omitted.

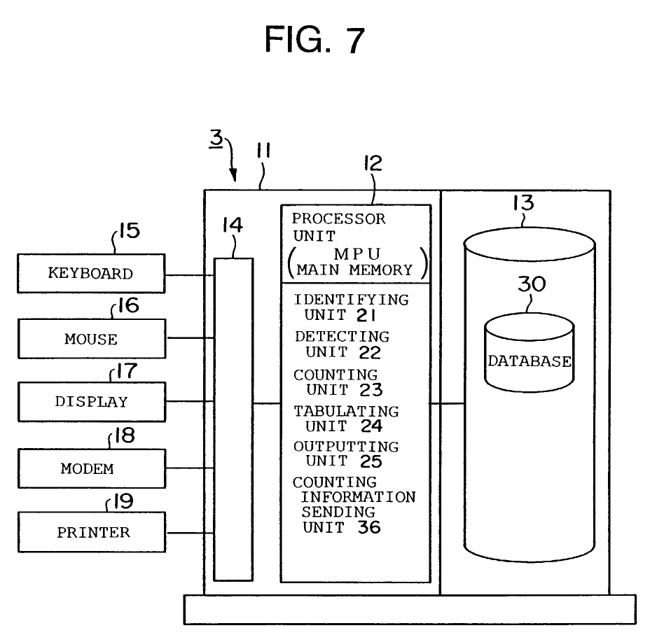

FIG. 7 is a drawing showing the schematic construction of the remote counting server 3 in this embodiment. This server 3 is approximately the same as the server 3 described above, although a different unit is realized by the processor unit 12 and the like.

The processor unit 12 realizes an identifying unit 31, a detecting unit 32, a counting unit 23, a tabulating unit 24, an outputting unit 25, and a counting information sending unit 36 through processing based on information from peripheral equipment and application software.

The identifying unit 31 has a function of identifying communication from the portable terminal 2 and specifies each portable terminal using a telephone number informed by a function of informing a telephone number each time a call is received.

The detecting unit 32 has a function of detecting a button operation signal, that is, a tone signal from the identified portable terminal.

Also, the counting information sending unit 36 sends information concerning counting to the portable terminal.

With this construction, the survey conducting entity accesses the site of the data center, requests a survey by inputting required items, and obtains a telephone number for the survey. Also, the survey conducting entity informs the investigators A and B of this telephone number for the survey and the contents of the survey.

The investigators A and B move to counting places (polling places) in accordance with the contents of this request and, when starting the survey, place calls with reference to the telephone number for the survey.

The server 3 receives these telephone calls, converts telephone numbers informed by the informing function into voice messages for confirmation, and returns the voice messages to the portable terminals.

The investigators A and B confirm that the telephone numbers have been normally returned before starting the survey.

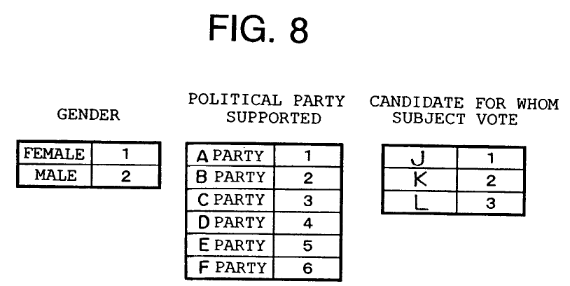

Then, the investigators A and B ask a voter (target person for survey), who has voted, about his/her gender, the political party he/she supports, and the candidate for whom he/she voted, and pushes corresponding numerical buttons of the portable terminal 2. The numerical buttons pushed during this operation correspond to survey items as shown in FIG. 8 and were informed as contents of the survey by the survey conducting entity.

It should be noted here that in the case where the terminal is handed to each voter in order to conduct the survey, the correspondences between survey items and input buttons may be explained by word oral. Alternatively, a list showing the correspondences like the list shown in FIG. 8 may be printed on paper or the like and the voter may input his/her answers by referring to the list.

In the case where the target person for survey is male, his supporting political party is the party “C”, and he voted for the candidate “J”, for instance, he inputs a number string of “231”.

Then, the survey proceeds to the next target person for survey.

It should be noted here that in order to establish the matching of inputted data, there may be pushed a predetermined input button (*, #, or the like) to input a stop signal before proceeding to the next target person for survey.

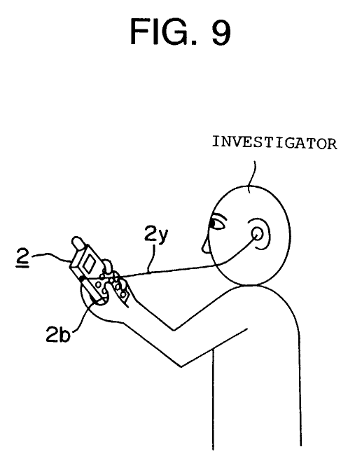

Also, numerals recognized by the server 3 using the function of the counting information sending unit 36 may be returned as a voice message, the investigator may listen to the voice message using an earphone 2y as shown in FIG. 9, and he/she may perform an input operation while performing confirmation.

The input buttons 2b used for the counting in this example are arranged within a range in which a single singer (thumb in this example) reaches each button under a state where the portable terminal 2 is held by one hand as shown in FIG. 9.

As described above, with the technique of this embodiment, it becomes possible to adopt a mobile telephone only with a conversation function as the portable terminal, which makes it possible to construct a system having high versatility.

The remote counting system, the remote counting method, and the computer-readable medium of the present invention are not limited to the embodiments described above. That is, needless to say, it is possible to make various changes and modifications without departing from the scope of the present invention.

In the embodiments described above, a button pushing signal is sent to the server each time an input button is pushed. However, there may be obtained a construction where a predetermined number of button pushing signals are sent by one operation.

For instance, an investigator asks a voter, who has voted, to answer survey items. In the case where the target person for survey is male, his supporting political party is the party “C”, and he voted for the candidate “J”, for instance, there are inputted numbers of “2, 3, and 1” in succession (pushes corresponding buttons) by referring to a list showing correspondences between the survey items and the numerical buttons like the list shown in FIG. 8. Following this, he pushes a predetermined button (the operation lever 2b1 or the like). In this manner, all of signals concerning one target person for survey are sent to the server 3 by one operation.

As described above, with the technique of the present invention, it becomes possible to provide a remote counting system, a remote counting method, and a computer-readable medium, with which it becomes possible to achieve labor saving in tabulating work and to expedite the tabulating work.

What is claimed is:

1. A remote counting server that is connected to a portable terminal comprising:
an identifying unit that identifies communication with each of a plurality of portable terminals;
a detecting unit that detects a button pushing operation signal generated by each identified portable terminal when an input button is pushed;
a counting unit that records the number of button pushing operations for each portable terminal based on the button pushing operation signal;
a tabulating unit that tabulates the counting results for all the portable terminals and/or each portable terminal; and
an outputting unit that visually outputs a result of the tabulation.

2. A remote counting server according to claim 1, wherein the remote counting server is connectable from a portable terminal having a display apparatus and identifies a portable terminal of the communication opposite party under a connection state using the display apparatus.

3. A remote counting server according to claim 1, wherein the remote counting server is connectable from a voice communication terminal and detects the button pushing operation signal as a voice signal.

4. A remote counting server according to claim 1, wherein the remote counting server includes a counting information sending unit that sends information concerning counting to the portable terminal.

5. A remote counting method that is applied to a remote counting server connected to a portable terminal, comprising:
identifying communication with each of a plurality of portable terminals;
detecting a button pushing operation signal generated by each identified portable terminal when an input button is pushed;
recording the number of button pushing operations for each portable terminal based on the button pushing operation signal;
tabulating the recorded number of button pushing operations for all the portable terminals and/or each portable terminal; and
outputting a result of the tabulation.

6. A computer-readable medium that stores a program, wherein a remote counting server connected to a portable terminal is allowed to execute:
identifying communication with each of a plurality of portable terminals;
detecting a button pushing operation signal generated by each identified portable terminal when an input button is pushed;
recording the number of button pushing operations for each portable terminal based on the button pushing operation signal;
tabulating the recorded number of button pushing operations for all the portable terminals and/or each portable terminal; and
outputting a result of the tabulation.

7. A remote counting system comprising a portable terminal that is capable of being carried to a counting place and a remote counting server that is connected to the portable terminal through a communication line,
wherein the portable terminal includes: an input button that inputs a button pushing operation signal through the pushing thereof; and a sending unit that sends the button pushing operation signal inputted using the input button to the remote counting server through the communication line,
the remote counting server includes: an identifying unit that identifies communication with the portable terminal; a detecting unit that detects the button pushing operation signal from the identified portable terminal; and a counting unit that records the number of button pushing operations of the portable terminal based on the detected button pushing operation signal.

8. A remote counting system according to claim 7, wherein the portable terminal is a mobile telephone having, as the input button, keys for dialing and/or a pointing device.

9. A remote counting system according to claim 7, wherein a predetermined button pushing operation signal is inputted by pushing the input button once and the counting unit performs the counting once in accordance with the predetermined button pushing operation signal.

10. A remote counting system according to claim 7, wherein the server includes a tabulating unit that tabulates button pushing operation signals from a plurality of portable terminals.

11. A remote counting system according to claim 7, wherein a voting result obtained as a result of an exit poll at a polling place is inputted as a button pushing operation signal by the input button of each portable terminal and the tabulating unit of the server judges who is sure to be elected by tabulating the button pushing operation signals from each portable terminal.
